(19) United States
(12) Patent Application Publication
(10) Pub. No.: US 2023/0036699 A1
(43) Pub. Date: Feb. 2, 2023

(54) CONTROLLING COUPLINGS BETWEEN QUANTUM DOTS IN A QUANTUM DOT ARRAY

(71) Applicant: Technische Universiteit Delft, Delft (NL)

(72) Inventors: Cornelis Jacobus VAN DIEPEN, Dreft (NL); Tzu-Kan HSIAO, (US); Lieven Mark Koenraad VANDERSYPEN, Delft (NL)

(73) Assignee: Technische Universiteit Delft, Delft (NL)

(21) Appl. No.: 17/759,006

(22) PCT Filed: Jan. 21, 2021
(86) PCT No.: PCT/EP2021/051397

§ 371 Date: Jul. 18, 2022

(30) Foreign Application Priority Data
Jan. 21, 2020 (NL) 2024724

(51) Int. Cl. G06N 10/20; G06N 10/80; G06N 10/40

(52) U.S. Cl. CPC G06N 10/20; G06N 10/80; G06N 10/40

(57) ABSTRACT

A method of controlling coupling of at least two quantum dots in a quantum dot array is described, wherein the method comprises: determining virtual gates for the quantum dots based on first crosstalk contributions of physical gates to dot potentials of quantum dots in the quantum dot array, a virtual gate voltage defining a linear combination of physical gate voltages to be applied to the physical gates for controlling at least one dot potential of a quantum dot or for controlling a coupling of at least two quantum dots in the quantum dot array, while at least partially compensating dot potential crosstalk due to the first crosstalk contributions; determining second crosstalk contributions of the virtual gates to a coupling between one or more pairs of quantum dots in the quantum dot array, the determining including determining partial derivatives of couplings between pairs of quantum dots in the quantum dot array with respect to the virtual gate voltages; determining enhanced virtual gates for the quantum dots based on the second crosstalk contributions, an enhanced virtual gate voltage defining a linear combination of the virtual gate voltages for controlling at least one dot potential or a coupling of a pair of quantum dots in the quantum dot array, while at least partially compensating coupling crosstalk due to the second crosstalk contributions; and, controlling the coupling of at least two quantum dots in the quantum dot array based on at least one of the enhanced virtual gates, the controlling including using the at least one of the enhanced virtual gates to tune the coupling of the at least two quantum dots to a target value.

### FIELD OF THE INVENTION

The invention relates to controlling couplings between quantum dots in a quantum dot array, and, in particular, though not exclusively, to methods and systems for controlling couplings between quantum dots in a quantum dot array and a computer program product for executing such methods.

### BACKGROUND OF THE INVENTION

Electrostatically-defined semiconductor quantum dot arrays have great application potential in spin-qubit quantum computation and quantum simulation. In these arrays, the chemical potentials of dots and the tunnel coupling between neighbouring dots are controlled electrostatically by gate voltages. By adjusting the dot potentials and tunnel couplings, the exchange coupling between electron spins in the quantum dots can be tuned to perform spin-qubit operations. In addition, the in-situ control of the parameters make quantum dot arrays a suitable platform for analog quantum simulation of Fermi-Hubbard physics, such as the Mott metal-to-insulator transition, Nagaoka ferromagnetism, Heisenberg spin chain, and D-wave superconductivity in the ladder materials.

Due to crosstalk, caused by capacitive coupling between gates and the quantum dot array, changing one gate voltage, does not change one but multiple parameters. Therefore, iterative adjustments of gate voltages are needed to reach the target values. To compensate for the crosstalk on the chemical potentials of the quantum dots, a set of virtual gates is defined as linear combinations of physical gate voltages to enable orthogonal control of chemical potentials of the quantum dots. The technique of crosstalk compensation for dot potentials has become a standard and essential technique in multi-dot experiments. At the same time, the crosstalk compensation for tunnel couplings is rarely performed in quantum dot devices.

The inter-dot tunnel coupling is approximately an exponential function of gate voltages. This exponential behaviour makes the crosstalk effect nonlinear and more difficult to calibrate. So far, tuning of multiple tunnel couplings in a multi-dot device is mostly done by iteratively adjusting gate voltages using manual or computer-automated procedures, examples of such procedures are described in the article of Van Diepen, C. J. et al. Automated tuning of inter-dot tunnel coupling in double quantum dots, Applied Physics Letters 113, 033101 (2018) and the article by Mills, A. R. et al. Computer-automated tuning procedures for semiconductor quantum dot arrays. Applied Physics Letters 115, 113501 (2019). These tuning methods include the selection of a target tunnel coupling configuration for a quantum dot and the determination of an initial set of barrier voltages based on the target tunnel coupling configuration. Thereafter, tunnel coupling strengths of each of the tunnel barriers in the quantum dot array are measured and compared with the target values. Based on the comparison, the barrier voltages are updated and the process is repeated until the measured coupling strengths approach the target values within a certain error margin.

This iterative process needs to be repeated for each target settings and thus is not suitable for fast individual control of tunnel couplings in a quantum dot array. Hence, from the above it follows there is a need in the art for improved schemes for controlling tunnel couplings in a quantum dot array. In particular, there is a need in the art for improved systems and method for controlling tunnel couplings in a quantum dot array.

### SUMMARY OF THE INVENTION

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. Additionally, the Instructions may be executed by any type of processors, including but not limited to one or more digital signal processors (DSPs), general purpose microprocessors, application specific integrated circuits (ASICs), field programmable logic arrays (FP-GAs), or other equivalent integrated or discrete logic circuitry.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In this application, methods and systems for controlling tunnel couplings in an array of quantum dots are described.

In an embodiment, the method may comprise at least one or more of the following steps: determining virtual gates for the quantum dots based on first crosstalk contributions of physical gates to dot potentials of quantum dots in the quantum dot array, a virtual gate voltage defining a linear combination of physical gate voltages to be applied to the physical gates for controlling at least one dot potential of a quantum dot or for controlling a coupling of at least two quantum dots in the quantum dot array, while at least partially compensating dot potential crosstalk due to the first crosstalk contributions; determining second crosstalk contributions of the virtual gates to a coupling between one or more pairs of quantum dots in the quantum dot array, the determining including determining partial derivatives of couplings between pairs of quantum dots in the quantum dot array with respect to the virtual gate voltages; determining enhanced virtual gates for the quantum dots based on the second crosstalk contributions, an enhanced virtual gate voltage defining a linear combination of the virtual gate voltages for controlling at least one dot potential or a coupling of a pair of quantum dots in the quantum dot array, while at least partially compensating coupling crosstalk due to the second crosstalk contributions; and, controlling the coupling of at least two quantum dots in the quantum dot array based on at least one of the enhanced virtual gates, the controlling including using the at least one of the enhanced virtual gates to tune the coupling of the at least two quantum dots to a target value.

In a further embodiment, the method may comprise at least one or more of the steps of: determining virtual gates B′, P′ for the quantum dots based on first crosstalk contributions of physical gates B, P to dot potentials of quantum dots in the quantum dot array, a virtual gate voltage defining a linear combination of physical gate voltages to be applied to the physical gates for controlling at least one dot potential of a quantum dot or for controlling a coupling of at least two quantum dots in the quantum dot array, while at least partially compensating dot potential crosstalk due to the first crosstalk contributions; determining second crosstalk contributions of the virtual gates to a coupling of at least two quantum dots in the quantum dot array, the determining including applying a voltage perturbation δ to at least one of the virtual gates and in response to the voltage perturbation δ measuring a change in of the coupling of the at least two quantum dots and fitting the change of the coupling to a function, preferably a linear function; determining enhanced virtual gates B^{†}, P^{†} for the quantum dots based on the second crosstalk contributions, an enhanced virtual gate voltage defining a linear combination of the virtual gate voltages for controlling at least one dot potential or a coupling of at least two quantum dots in the quantum dot array, while at least partially compensating coupling crosstalk due to the second crosstalk contributions; and, controlling the coupling of at least two quantum dots in the quantum dot array based on at least one of the enhanced virtual gates B^{†}, P^{†}, the controlling including using the at least one of the enhanced virtual gates to tune the coupling of the at least two quantum dots to a target value.

The control method enables orthogonal control of coupling between quantum dots in a quantum dot array, typically a gated quantum dot array. The inventors found out that despite the exponential dependence of coupling, ratios between crosstalk factors in the exponent of the coupling (which may be referred to as coupling crosstalk ratios) may be efficiently be obtained from the derivatives of couplings, e.g. tunnel couplings, with respect to virtual gate voltages. These coupling crosstalk ratios may be used to defines a new set of virtual gates, which includes the crosstalk compensation for the couplings. These new set of virtual gates that allow crosstalk compensation allows enhanced control of the quantum dot array and therefore may be referred to as enhanced virtual gates. The enhanced virtual gates allow efficient orthogonal control of couplings in quantum dots. In addition, even though the couplings scale exponentially with the corresponding virtual gates, the control remains orthogonal over a wide range of tunnel coupling values, since the scheme compensates for the crosstalk in the exponential dependence rather than just linearize the crosstalk.

In an embodiment, the coupling of the at least two quantum dots may be at least one of: a tunnel coupling, a co-tunnelling coupling, an exchange coupling parameter and/or a capacitive coupling. Hence, the control schemes described by the embodiments in this application may be used to control different types of couplings that may exist between quantum dots in a quantum dot array.

In an embodiment, fitting the change in the coupling to a function may include: determining a ratio between a change of a dot coupling and the voltage perturbation δ, the ratio defining at least one of the second crosstalk contributions.

In an embodiment, the first crosstalk contributions may define elements of a dot potential crosstalk matrix C defining virtual gates P′,B′ for orthogonal control of the dot potentials as a linear combination of the physical gates P,B.

In an embodiment, the second crosstalk contributions may define elements of a coupling crosstalk matrix T defining enhanced virtual gates P^{†},B^{†} for orthogonal control of a coupling of at least two quantum dots as a linear combination of the virtual gates P′,B′.

In an embodiment, the determining enhanced virtual gates B^{†}, P^{†} may further include: determining a combined crosstalk matrix based on the dot potential crosstalk matrix C and the coupling crosstalk matrix T, the combined crosstalk matrix defining enhanced virtual gates P^{†},B^{†} for orthogonal control of coupling of the quantum dots in the quantum dot array based on a linear combination of the physical gate voltages P,B.

In an embodiment, controlling a coupling parameter may further include: determining a linear combination of physical gate voltages based on the inverse of the combined crosstalk matrix.

In an embodiment, controlling a coupling of the at least two quantum dots may further include: determining an inverse of the coupling crosstalk matrix T⁻¹; and, determining a linear combination of virtual gate voltages P′, B′ to orthogonally control the coupling of the at least two quantum dots based on the inverse of the coupling crosstalk matrix T⁻¹.

In an embodiment, the coupling may be a tunnel coupling that is modelled as a function having one variable wherein the variable is defined as a linear combination of the virtual gates P′, B′.

In an embodiment, the function may be an exponential function including a variable Φᵢⱼ which is defined as a linear combination of the virtual gates P′, B′.

In an embodiment, the virtual gates B′, P′ include one or more virtual barrier gates B′ for controlling couplings of quantum dots in the quantum dot array while at least partially compensating dot potential crosstalk.

In an embodiment, the virtual gates B′, P′ may include one or more virtual plunger gates P′ for controlling dot potentials of one or more quantum dots in the array of quantum dots, while at least partially compensating dot potential crosstalk.

In an embodiment, the array of quantum dots may be a one-dimensional array of quantum dots, a two-dimensional array of quantum dots or a three dimensional array of quantum dots.

In an aspect, the invention may relate to a system comprising an array of quantum dots; a controller connected to the array of quantum dots for controlling a coupling of at least wo quantum dots in the array of quantum dots, preferably the coupling of the at least two quantum dots is at least one of a tunnel coupling, a co-tunnelling coupling, an exchange coupling parameter and/or a capacitive coupling, wherein the controller may be configured to perform one or more of the following steps: determining virtual gates B′, P′ for the quantum dots based on first crosstalk contributions of physical gates B, P to dot potentials of quantum dots in the quantum dot array, a virtual gate voltage defining a linear combination of physical gate voltages to be applied to the physical gates for controlling at least one dot potential of a quantum dot or for controlling a coupling of at least two quantum dots in the quantum dot array, while at least partially compensating dot potential crosstalk due to the first crosstalk contributions; determining second crosstalk contributions of the virtual gates to a dot coupling of at least two quantum dots in the quantum dot array, the determining including applying a voltage perturbation δ to at least one of the virtual gates and in response to the voltage perturbation δ measuring a change in of the coupling of the at least two quantum dots and fitting the change of the coupling to a function, preferably a linear function; determining enhanced virtual gates B^{†}, P^{†} for the quantum dots based on the second crosstalk contributions, an enhanced virtual gate voltage defining a linear combination of the virtual gate voltages for controlling at least one dot potential or a coupling of at least two quantum dots in the quantum dot array, while at least partially compensating coupling crosstalk due to the second crosstalk contributions; and, controlling the coupling of at least two quantum dots in the quantum dot array based on at least one of the enhanced virtual gates B^{†}, P^{†}, the controlling including using the at least one of the enhanced virtual gates to tune the coupling of the at least two quantum dots to a target value.

In a further aspect, the invention may relate to a controller that is connectable to an array of quantum dots for controlling a coupling of at least two quantum dots in the array of quantum dots, preferably the coupling of the at least two quantum dots is at least one of a tunnel coupling, a co-tunnelling coupling, an exchange coupling parameter and/or a capacitive coupling, wherein the controller may be configured to perform one or more of the following steps: determining virtual gates B′, P′ for the quantum dots based on first crosstalk contributions of physical gates B, P to dot potentials of quantum dots in the quantum dot array, a virtual gate voltage defining a linear combination of physical gate voltages to be applied to the physical gates for controlling at least one dot potential of a quantum dot or for controlling a coupling of at least two quantum dots in the quantum dot array, while at least partially compensating dot potential crosstalk due to the first crosstalk contributions; determining second crosstalk contributions of the virtual gates to a dot coupling of at least two quantum dots in the quantum dot array, the determining including applying a voltage perturbation δ to at least one of the virtual gates and in response to the voltage perturbation δ measuring a change in of the coupling of the at least two quantum dots and fitting the change of the coupling to a function, preferably a linear function; determining enhanced virtual gates B^{†}, P^{†} for the quantum dots based on the second crosstalk contributions, an enhanced virtual gate voltage defining a linear combination of the virtual gate voltages for controlling at least one dot potential or a coupling of at least two quantum dots in the quantum dot array, while at least partially compensating coupling crosstalk due to the second crosstalk contributions; and, controlling the coupling of at least two quantum dots in the quantum dot array based on at least one of the enhanced virtual gates B^{†}, P^{†}, the controlling including using the at least one of the enhanced virtual gates to tune the coupling of the at least two quantum dots to a target value.

In yet another aspect, the invention may relate to a method of controlling coupling between quantum dots in an array of quantum dots, wherein the method may include one or more of the following steps: determining target values for coupling of pairs of quantum dots in the array of quantum dots, a coupling of a pair of quantum dots defining an inter-dot coupling; determining crosstalk contributions on the inter-dot coupling, a crosstalk contribution representing crosstalk of a gate voltage on a dot coupling; selecting a pair of quantum dots, the pair including quantum dot i and a quantum dot j, and determining one or more crosstalk contributions of the virtual gates B′ on the dot couplings.

In an embodiment, the determining of the one or more crosstalk contributions may include: determining a voltage perturbation δBₖₗ′ for determining crosstalk contributions for a virtual gate Bₖₗ′ on the dot coupling tᵢⱼ; applying the voltage perturbation δBₖₗ′ to the virtual gate Bₖₗ′, while keeping the voltage on the further virtual gates constant and measuring a change in the dot coupling δtᵢⱼ in response to the application of the voltage perturbation; determining a ratio of the change δtᵢⱼ in the dot coupling and the voltage perturbation δBₖₗ′, the ratio defining a crosstalk contribution for virtual gate Bₖₗ′ on dot coupling tᵢⱼ; determining a coupling crosstalk matrix T, the coupling crosstalk matrix T defining enhanced virtual gates B^{†} as a linear combination of the virtual gates B′ᵢⱼ; and, orthogonally controlling a dot coupling based on the enhanced virtual gates B^{†}.

In an embodiment, the method may include orthogonally controlling a dot coupling based on the enhanced virtual gates B^{†}.

In an embodiment, the orthogonal control of the dot coupling may include: determining a virtual gate voltage increment ΔB^{†} for an enhanced virtual gate to set a dot coupling to a target value, while at least partially compensating coupling crosstalk due to the crosstalk contributions; determining a linear combination of physical gate voltages based on the inverse of the coupling crosstalk matrix to achieve the virtual gate voltage increment ΔB^{†} for the enhanced virtual gate; and, applying the linear combination of physical gate voltages to the physical gates of the quantum dot array to achieve the virtual gate voltage increment ΔB^{†}, while at least partially compensating coupling crosstalk due to the crosstalk contributions.

In an aspect, the invention may relate to a method of controlling coupling of quantum dots in an array of quantum dots, wherein the method may include one or more of the following steps: determining one or more target values for one or more dot couplings of one or more pairs of quantum dots in the array of quantum dots; selecting a dot coupling tᵢⱼ for a pair of quantum dots, the pair including quantum dot i and a quantum dot j; determining one or more crosstalk contributions of virtual gates B′ on the dot coupling tᵢⱼ; using the crosstalk contributions to determine a crosstalk matrix, the crosstalk matrix defining first intermediate virtual gates B^{*1} in terms of virtual gates B′, the first intermediate virtual gates B^{*1} being configured to compensate for crosstalk on dot coupling tᵢⱼ; and, using intermediate virtual gate Bᵢⱼ^{*1} to tune dot coupling tᵢⱼ to the target value.

In an embodiment, using intermediate virtual gate Bᵢⱼ^{*1} to tune dot coupling tᵢⱼ may include: determining a voltage value ΔBᵢⱼ^{*1} for tuning dot coupling tᵢⱼ towards the target value using first intermediate virtual gate Bᵢⱼ^{*1}; using the inverse of the crosstalk matrix to determine a linear combination of physical gate voltages to tune intermediate virtual gate Bᵢⱼ^{*1} based on the determined voltage value ΔBᵢⱼ^{*1}; and, using the linear combination of physical gate voltages to tune dot coupling tᵢⱼ to the target value.

In an embodiment, the method may further comprise: before determining the one or more crosstalk contributions, measuring the selected dot coupling tᵢⱼ; and, tuning the dot coupling tᵢⱼ above a predetermined threshold value based on virtual gate Bᵢⱼ′ if the tunneling coupling tᵢⱼ is lower than the predetermined threshold value; In an embodiment, the determining one or more crosstalk contributions may comprise: applying a voltage perturbation δBₖₗ′, to a virtual gate Bₖₗ′ while keeping the voltage on the further virtual gates constant and measuring a change in the dot coupling δtᵢⱼ in response to the application of the voltage perturbation.

In an embodiment, the method may further comprise: selecting a further dot coupling, tₖₗ for a pair of quantum dots, the pair including quantum dot k and a quantum dot l; determining one or more crosstalk contributions of the intermediate virtual gates B^{*1} on the dot coupling tₖₗ; updating the crosstalk matrix based on the one or more crosstalk contributions of intermediate virtual gates B^{*1}; using the updated crosstalk matrix to define second intermediate virtual gates B^{*2}, which are configured to compensate for the crosstalk on tᵢⱼ and tₖₗ; and, using second intermediate tunnel gate Bₖₗ^{*2} to tune dot coupling tₖₗ to a target value based on the updated crosstalk matrix.

The invention may also include systems and controller that are configured to execute the above described methods.

The invention may also relate to a software program product comprising software code portions configured for, when run in the memory of a computer, executing the any of the method steps described above.

The invention will be further illustrated with reference to the attached drawings, which schematically will show embodiments according to the invention. It will be understood that the invention is not in any way restricted to these specific embodiments.

### BRIEF DESCRIPTION OF THE DRAWINGS

FIG. 1 depicts an image of a gated quantum dot array;

FIG. 2 illustrates tunnel coupling crosstalk when controlling a quantum dot array;

FIG. 3 depicts a flow diagram of a method of controlling tunnel couplings in a quantum dot array according to an embodiment of the invention.

FIG. 4 illustrates orthogonal control of tunnel couplings according to an embodiment of the invention;

FIG. 5A-5D depict experimental data of measuring tunnel coupling contributions according to an embodiment of the invention;

FIG. 6A-6F depict experimental data illustrating orthogonal control of tunnel couplings according to an embodiment of the invention;

FIGS. 7A and 7B depict experimental data illustrating orthogonal control of tunnel couplings for different regimes;

FIG. 8 depicts a flow diagram of a method of controlling tunnel couplings in a quantum dot array according to an embodiment of the invention;

FIG. 9 illustrates setting tunnel couplings to target values based on enhanced virtual gates according to an embodiment of the invention;

FIG. 10 depicts orthogonal control of tunnel couplings according to another embodiment of the invention;

FIG. 11 illustrates setting tunnel couplings to target values based on enhanced virtual gates according to another embodiment of the invention;

FIG. 12A-12F illustrate experimental data illustrating orthogonal control of tunnel couplings according to an embodiment of the invention;

FIG. 13 depicts a schematic of a 2D quantum dot array.

FIG. 14 depicts orthogonal control of tunnel couplings according to yet another embodiment of the invention;

### DETAILED DESCRIPTION

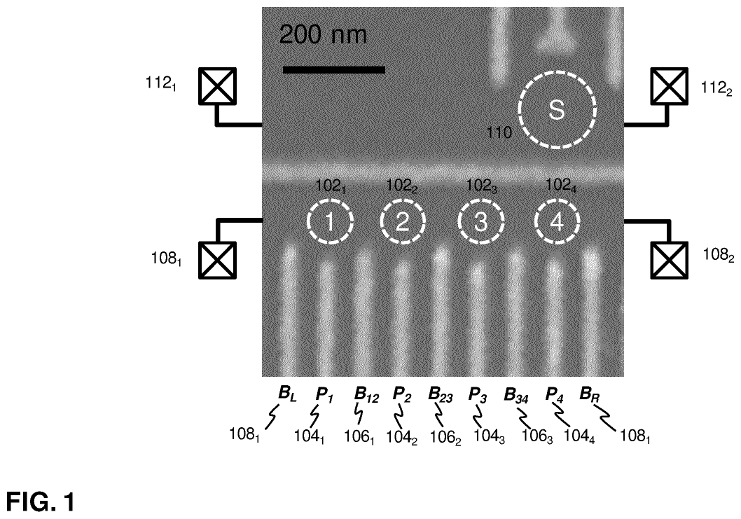

FIG. 1 depicts a scanning electron microscopy (SEM) image of an example of a quantum dot array. Such arrays may be readily implemented in a 2DEG heterostructure, e.g. a GaAs or InGasAs heterostructures. The dashed circles indicate positions of (in this example) four quantum dots 102₁₋₄ and an additional quantum dot 110 that can be configured as a charge sensor. The crossed squares indicate reservoirs connected to ohmic contacts. The quantum dots 102₁₋₄ may be controlled by applying voltages gates, for example to plungers gate electrodes, P, and barrier gate electrodes, B. Each plunger gate, Pᵢ, 104₁₋₄ is configured to control the chemical potential of dot i. This potential may also be referred to as the dot potential. Similarly, each barrier gate, Bᵢⱼ, 106₁₋₃ is configured to control the inter-dot tunnel couplings, tᵢⱼ (or in short tunnel couplings) between neighbouring dots i and j. The gates may be connected to a bias-tee for fast control of the dot potential and the inter-dot couplings using for example an arbitrary waveform generator. This way a plurality of tunnel junction coupled quantum dots (in this example four dots) may be formed. Outer barriers gates, B_{L} and B_{R}, may be used to control the tunnel coupling to the left and right charge reservoir 108_{1,2} respectively. In addition, charge sensing dot S 110 may be operated as a charge sensor which is capacitively coupled to one of the quantum dots of the quantum dot array. A charge transition in the quantum dot array may be detected by the charge sensor as e.g. a change in the conductance of the charge sensor. The change in conductance may be measured using radio-frequency (RF) reflectometry to achieve fast read-out of the charge configuration.

A change in a voltage applied to one or more gates, e.g. the plunger gates P and/or barrier gates B, may introduce crosstalk effects on dot potentials in the quantum dot array due to cross-capacitance coupling (or in short crosstalk coupling). In multi-dot applications, typically the dot-potential crosstalk of the gates P and B is characterized (measured) and defined on the basis of a dot potential crosstalk matrix C. The measured dot-potential crosstalk may be used to define virtual gates, e.g. plunger gates P′ and virtual barrier gates B′, wherein each virtual gate is configured to control a dot potential of a quantum dot in the array without affecting the dot potentials of the other quantum dots in the array. Thus, the dot potential crosstalk matrix C may be used to define a first set of virtual gates {P′,B′} for orthogonal control of the dot potentials as a linear combination of the physical gate voltages {P,B}. When applying this to the array of FIG. 1, the following relation between the gates and the virtual gates can be obtained:

$$( \begin{matrix}{P}_{1}^{′} \\ {P}_{2}^{′} \\ {P}_{3}^{′} \\ {P}_{4}^{′} \\ {B}_{12}^{′} \\ {B}_{23}^{′} \\ {B}_{34}^{′}\end{matrix} ) = ( \begin{matrix}1 & {α}_{12} & {α}_{13} & {α}_{14} & {α}_{15} & {α}_{16} & {α}_{17} \\ {α}_{21} & 1 & {α}_{23} & {α}_{24} & {α}_{25} & {α}_{26} & {α}_{27} \\ {α}_{31} & {α}_{32} & 1 & {α}_{34} & {α}_{35} & {α}_{36} & {α}_{37} \\ {α}_{41} & {α}_{42} & {α}_{43} & 1 & {α}_{45} & {α}_{46} & {α}_{47} \\ 0 & 0 & 0 & 0 & 1 & 0 & 0 \\ 0 & 0 & 0 & 0 & 0 & 1 & 0 \\ 0 & 0 & 0 & 0 & 0 & 0 & 1\end{matrix} ) ( \begin{matrix}{P}_{1} \\ {P}_{2} \\ {P}_{3} \\ {P}_{4} \\ {B}_{12} \\ {B}_{23} \\ {B}_{34}\end{matrix} ) \qquad ( 1 )$$

The linear combination of the physical gates, e.g. the plunger gate voltages P and the physical barrier gate voltages B, to orthogonally control the dot potentials may be obtained from the inverse dot potential crosstalk matrix C⁻¹. Here, orthogonal control refers to a type of control based on the virtual gate voltages {P′,B′} wherein a change in the virtual gate voltage Pᵢ′ only induces a change in the dot potential of quantum dot i, while the dot potentials of the other quantum dots in the array are not affected (or minimally affected).

The off-diagonal elements αᵢⱼ of the dot potential crosstalk matrix C may define (normalized) dot potential crosstalk ratios from gate voltage to the dot potential of dot i. For example, when applied to the array of FIG. 1, dot potential crosstalk ratio

$${α}_{12} = \frac{\partial {μ}_{1}}{\partial {P}_{2}} / \frac{\partial {μ}_{1}}{\partial {P}_{1}}$$

may define the crosstalk from plunger gate voltage P₂ of the second dot to the dot potential of the first quantum dot. Similarly, dot potential crosstalk ratio α₁₃ may define the crosstalk from plunger gate voltage P₃ to the dot potential of the first quantum dot:

$${α}_{13} = \frac{\partial {μ}_{1}}{\partial {P}_{3}} / \frac{\partial {μ}_{1}}{\partial {P}_{1}} ;$$

potential crosstalk ratio α₁₄ may define the crosstalk from plunger gate voltage P₄ to the potential of the first quantum dot; dot potential crosstalk ratio α₅ may define the crosstalk from barrier gate voltage B₁₂ to the dot potential of the first quantum dot:

$${α}_{15} = \frac{\partial {μ}_{1}}{\partial {B}_{12}} / \frac{\partial {μ}_{1}}{\partial {P}_{1}}$$

etc. (all αᵢⱼ are positive).

As shown from equation (1), elements of the dot potential crosstalk matrix C that relate to crosstalk effects of a gate voltage to the tunnel coupling of a tunnel barrier are not taken into account. These values are set to zero. Typical quantum dot control systems use this approximation because the crosstalk influence of a gate voltage on tunnel couplings requires a non-linear (exponential) description of the system, which makes orthogonal control a non-trivial problem. Thus, the first set of virtual gate voltages {P′, B′} for orthogonal dot potential control as described with reference to equation (1) above, does not incorporate tunnel coupling crosstalk effects. Therefore, applying a virtual barrier voltage Bᵢⱼ′ not only changes the tunnel coupling tᵢⱼ between dot i and dot j, but also affects nearby tunnel couplings.

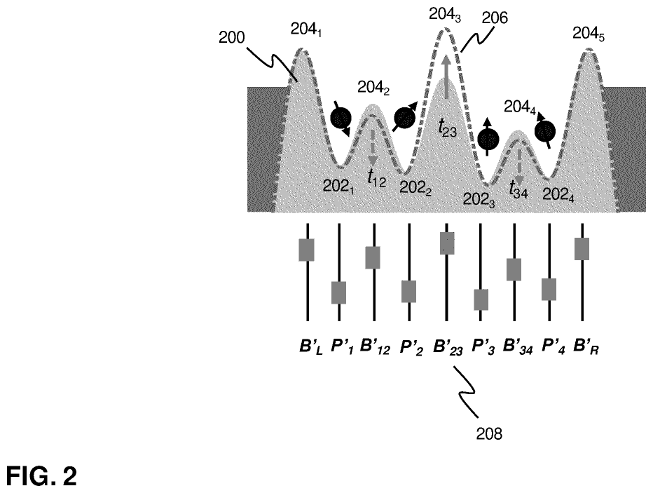

FIG. 2 illustrates the influence of a change in the virtual barrier voltage on the shape of the energy landscape of a quantum dot array, for example a linear quantum dot array as depicted in FIG. 1. As shown in FIG. 2, the potential landscape 200 includes energy minima 202₁₋₄ wherein each energy minimum may schematically represent the potential well of a quantum dot, which can be controlled by applying a voltage to a gate, e.g. a plunger gate P. The quantum dots are separated by potential maxima 204₁₋₅ representing a potential barrier. Such a potential barrier may determine a tunnel coupling between two neighbouring dots and can be controlled by applying a voltage to a barrier gate B. Increasing the tunnel coupling provides an increased coupling between electron states in both quantum dots, allowing electrons to tunnel more easily from one quantum dot to the other quantum dot. Such fine control of the tunnel couplings is for example needed when the quantum dots in the array are used as qubits of a quantum computer. The size of the potential barrier may provide an indication of the strength of the tunnel coupling tᵢⱼ between neighbouring quantum dots. Here, a “larger” tunnel barrier may indicate a “weak” tunnel coupling and a “small” tunnel barrier a “high” tunnel coupling.

As shown in FIG. 2, changing virtual barrier voltage B₂₃′ (which controls the tunnel coupling t₂₃ between the quantum dot 2 and 3 will influence the shape of the potential landscape of the quantum dot array. The grey area 200 schematically illustrates the original shape of the energy landscape before changing the barrier voltage and the dashed line 206 illustrate the shape of the energy landscape after decreasing the virtual barrier voltage B₂₃′ (which increases the coupling strength t₂₃ between the dots). The virtual gate voltages are controlled based on a cross-capacitance matrix as described above with reference to equation (1). Adjusting virtual barrier gate voltage B₂₃′ to increase tunnel coupling t₂₃ keeps the dot potentials of the quantum dots unchanged, but will influence tunnel couplings of nearby quantum dots (in the example it lowers the tunnel couplings t₁₂ and t₃₄). This effect is caused by the fact that the virtual gate voltages {P′,B′} for orthogonal dot potential control do not take the cross-talk contribution of the gates on the tunnel couplings into account. In order to address the problem of the effect of crosstalk on the tunnel couplings in a quantum dot array, the inventors developed schemes for efficient orthogonal control of tunnel couplings in a quantum dot array.

To that end, the effect of the gate voltages onto the tunnel couplings needs to be taken into account. For a large inter-dot barrier, a tunnel coupling tᵢⱼ between dot i and j may be approximated by the following exponential function:

$${t}_{ij} = {t}_{0} exp ( {Φ}_{ij} ) = {t}_{0} exp ( {\sum }_{k} {Λ}_{k}^{ij} {P}_{k}^{′} + {\sum }_{kl} {Γ}_{kl}^{ij} {B}_{kl}^{′} ) \qquad ( 2 )$$

wherein Φᵢⱼ is a spatial integral of −{square root over (2mₑ(Vᵢⱼ(x)−E))} (mₑ is the electron mass, Vᵢⱼ(x) is the potential of the barrier at a position x, and E is the energy of the tunnel electron). As shown by equation (2), Φᵢⱼ is expressed as a linear combination of the virtual gate P′ and B′ with pre-factors Λ and Γ respectively. Here, Λₖ^{ij} represent a factor for Pₖ′, and Γₖₗ^{ij} denotes a factor for Bₖₗ′. Based on equation (2) and the first set of virtual gates {P′,B′} that enable orthogonal control of the dot potentials, a second set of virtual gates {P^{†},B^{†} } may be defined that allow orthogonal control of the tunnel couplings. These virtual gates, which allow enhanced control of the quantum dot, may be referred to as enhanced virtual gates.

A tunnel coupling crosstalk matrix T may be defined which defines the set of enhanced virtual gates {P^{†},B^{†} } for orthogonal control of the tunnel couplings as a linear combination of virtual gate voltages of the first set of virtual gates {P′,B′}, that are configured for orthogonal control of the dot potentials:

$$( \begin{matrix}{P}_{1}^{†} \\ {P}_{2}^{†} \\ {P}_{3}^{†} \\ {P}_{4}^{†} \\ {B}_{12}^{†} \\ {B}_{23}^{†} \\ {B}_{34}^{†}\end{matrix} ) = ( \begin{matrix}1 & 0 & 0 & 0 & 0 & 0 & 0 \\ 0 & 1 & 0 & 0 & 0 & 0 & 0 \\ 0 & 0 & 1 & 0 & 0 & 0 & 0 \\ 0 & 0 & 0 & 1 & 0 & 0 & 0 \\ {β}_{51} & {β}_{52} & {β}_{53} & {β}_{54} & 1 & {β}_{56} & {β}_{57} \\ {β}_{61} & {β}_{62} & {β}_{63} & {β}_{64} & {β}_{65} & 1 & {β}_{67} \\ {β}_{71} & {β}_{72} & {β}_{73} & {β}_{74} & {β}_{75} & {β}_{76} & 1\end{matrix} ) ( \begin{matrix}{P}_{1}^{′} \\ {P}_{2}^{′} \\ {P}_{3}^{′} \\ {P}_{4}^{′} \\ {B}_{12}^{′} \\ {B}_{23}^{′} \\ {B}_{34}^{′}\end{matrix} ) . \qquad ( 3 )$$

Here, a tunnel coupling crosstalk ratio βᵢⱼ may define the ratio between pre-factors. This way, each tunnel coupling crosstalk ratio may be defined in terms of the factors Λ and Γ: β₅₁=λ₁²²/Γ₁₂¹², β₅₂=Δ₂¹²/Γ₁₂¹², β₅₆=Γ₂₃¹²/Γ₁₂¹², etc. The linear combination of P′ and B′ to orthogonally control the tunnel couplings is obtained from the inverse of the tunnel coupling crosstalk matrix T⁻¹. This way, the virtual barrier gate Bᵢⱼ^{†} orthogonally links to Φᵢⱼ with a factor Γᵢⱼ^{ij}, so that it can be used for orthogonal control of tunnel couplings. Although tᵢⱼ scales exponentially with P′ and B′, as long as the factors Λ and Γ remain the same, orthogonal control with B^{†} remains valid for any value of tunnel couplings.

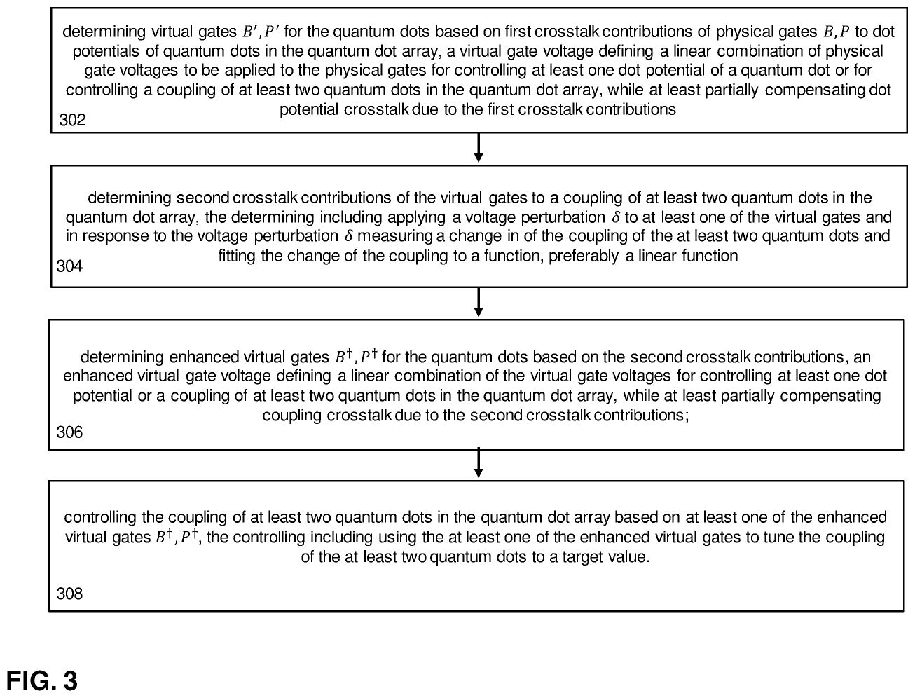

FIG. 3 depicts a flow diagram of a method of controlling couplings between quantum dots in a quantum dot array according to an embodiment of the invention. As shown in this figure, the method may include a step of determining virtual gates B′, P′ for the quantum dot array based on first cross-capacitance contributions of physical gates B, P of the quantum dot array to the dot potentials of quantum dots in the quantum dot array (step 302).

Here, a virtual gate voltage may define a linear combination of physical gate voltages to be applied to the physical gates of the quantum dot array for controlling a dot potential of a quantum dot or a tunnel coupling between at least one pair of quantum dots, and for compensating or at least partially compensating dot potential crosstalk due to the first crosstalk contributions. The crosstalk contributions of physical gates B, P may be determined by applying a small to change to a gate voltage applied to one quantum dot in the array and measuring a change in the dot potential of one or more other quantum dots in the array. The crosstalk contributions may be used to determine dot potential crosstalk ratios of a dot potential crosstalk matrix as described above with reference to equation (1). Here, the dot potential crosstalk matrix provides the relation between the virtual gates B′, P′ and the physical gates B, P.

Thereafter, second crosstalk contributions of the virtual gates to the tunnel couplings between pairs of quantum dots in the quantum dot array may be determined (step 304). These contributions may be determined by applying a voltage perturbation δB′ to at least one of the virtual gates B′ to control a coupling between quantum dots or voltage perturbation δP′ to at least one of the gates P′ to control a dot potential. In response to the voltage perturbation a change in a coupling δt between quantum dots in the quantum dot array may be measured and each of these changes δt in the coupling may be fitted to a linear function. This way, coupling crosstalk contributions may be determined, which may be used to determine coupling crosstalk ratios of the coupling crosstalk matrix T.

The thus determined second crosstalk contributions, including partial derivatives

$$\frac{\partial {t}_{ij}}{\partial {B}_{kl}} ,$$

may be used to relate enhanced virtual gates B^{†}, P^{†} for the quantum dot array to virtual gates B′, P′. Here, an enhanced virtual gate voltage may define a linear combination of the virtual gate voltages for controlling at least one dot potential or a coupling between quantum dots, and for at least partially compensating coupling crosstalk due to the second crosstalk contributions (step 306).

Thus, the crosstalk contributions may be used to determine coupling crosstalk ratios for the coupling crosstalk matrix T for providing the relation between enhanced virtual gates B^{†}, P^{†} and virtual gates B′, P′. Finally, the method may include a step of controlling a coupling between quantum dots in the array on the basis of one of the enhanced virtual gates B^{†}, P^{†}, wherein the controlling may include using an enhanced virtual gate for tuning a coupling between quantum dots in the quantum dot array to a target value (step 308).

Hence, the method as depicted in FIG. 3 enables orthogonal control of coupling between quantum dots in a quantum dot array, typically a gated quantum dot array. The inventors have found that despite the exponential dependence of coupling on gate voltages, ratios between crosstalk factors in the exponent of a coupling between at least two quantum dots, e.g. a tunnelling coupling (which may be referred to as coupling crosstalk ratios) may be efficiently be obtained from the derivatives of couplings with respect to virtual gate voltages, i.e. a change in a coupling, e.g. a tunnelling coupling between two quantum dots in the array in response to an perturbation in the virtual gate voltage of a further quantum dot in the array. This way, calibration of dot couplings and configuration of quantum dots for certain applications, e.g. quantum simulations using gate-controlled quantum dot arrays, can be efficiently achieved. The calibration method described with reference to FIG. 3 may be referred in this application as the differential calibration method or in short the differential method.

Different coupling between quantum dots may be controlled. The couplings may include: tunnel coupling, a co-tunnelling coupling, an exchange coupling and/or a capacitive coupling.

For example, in an embodiment, the enhanced virtual gate Bᵢⱼ^{†} may facilitate orthogonal control of the exchange coupling Jᵢⱼ, between two spins in dots i and j. It is noted that the that Jᵢⱼ=(∈ᵢⱼ²+8tᵢⱼ²+∈ᵢⱼ)/2, where ∈ᵢⱼ is the energy detuning between (2,0) and (1,1) singlets, near the (2,0)-(1,1) transition, and the exchange coupling Jᵢⱼ=4tᵢⱼ²/E_{c}, where E_{c} is the charging energy, when the single dot levels in the two dots are aligned. Since Bᵢⱼ^{†} orthogonally controls tᵢⱼ while keeping the dot potentials fixed (Δ∈ᵢⱼ=0), Bᵢⱼ^{†} also orthogonally controls Jᵢⱼ.

In another embodiment, a set of enhanced virtual gates B^{†}, P^{†}, based on the crosstalk of B′. P′ to the distances between charges, may facilitate orthogonal control of the capacitance couplings because a capacitance coupling is a function of the distance and the distances are orthogonally controlled with B^{†}, P^{†}.

In an embodiment, a set of enhanced virtual gates B^{†}, P^{†}, based on the crosstalk of B′, P′ to the products of tunnel couplings involved in a co-tunneling path, may facilitate orthogonal control of the capacitance couplings because a co-tunnel coupling is a function of the product of the tunnel couplings involved and the products are orthogonally controlled with B^{†}, P^{†}.

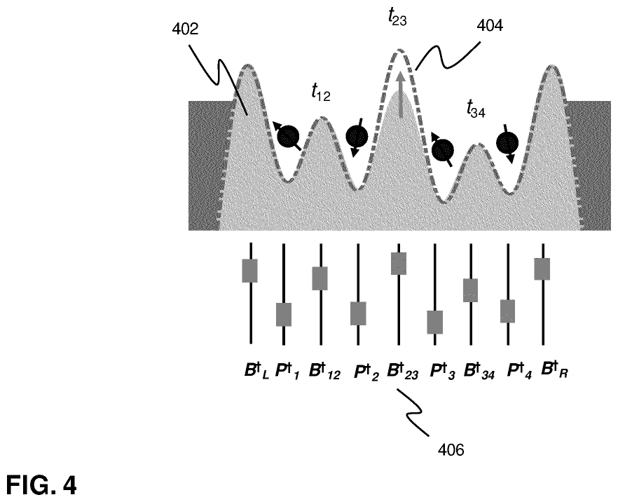

FIG. 4 illustrates the orthogonal control of tunnel couplings as e.g. described with reference to FIG. 3. As shown in this figure, changing enhanced virtual barrier voltage B₂₃^{†} (which controls the tunnel coupling t₂₃ between the 2^{th} and 3^{rd} quantum dot) will influence the shape of the potential landscape of the quantum dot array. The grey area 402 denotes the original landscape, and the dashed line 404 indicates the landscape when the voltage of the enhanced virtual barrier B₂₃^{†} is decreased. Due to the fact that the tunnel coupling crosstalk is taken into account for the enhanced virtual gate barriers, tunnel coupling t₂₃ can orthogonally controlled using the enhanced virtual gate B₂₃^{†} 406 without affecting other tunnel couplings and dot potentials.

A double quantum dot system in the quantum dot array of FIG. 1, e.g. quantum dot 2 and 3, may be used to demonstrate determining the tunnel coupling cross-capacitance ratios between Γ from the derivatives of tunnel couplings with respect to B′.

First, capacitive couplings from P and B to each dot potential may be determined. This is done by measuring the shift

$$δ {P}_{i} ( = δ {P}_{i}^{′} since \frac{δ {P}_{i}^{′}}{δ {P}_{i}} = 1 )$$

in the voltage on Pᵢ for charge addition to dot i with a voltage change δPⱼ (δBᵢⱼ). Here the voltage change may be in the order of mVs, e.g. 5 mV or less. The measured capacitive couplings

$$( \frac{δ {P}_{i}^{′}}{δ {P}_{j}} and \frac{δ {P}_{i}^{′}}{δ {B}_{ij}} )$$

are then used to form dot potential crosstalk matrix C as described with reference to equation (1). Based on the matrix, the potential of dot i may be orthogonally tuned using potential Pᵢ′ and keep the potential unchanged when Bᵢⱼ′ is adjusted. At this point, the crosstalk compensation only makes the control of dot potentials orthogonal to each other, not the tunnel couplings. Tuning tᵢⱼ by varying Bᵢⱼ′ typically affects the tunnel coupling tₖₗ of neighbouring dot pairs since the crosstalk from Bᵢⱼ′ to tₖₗ has not been characterized yet.

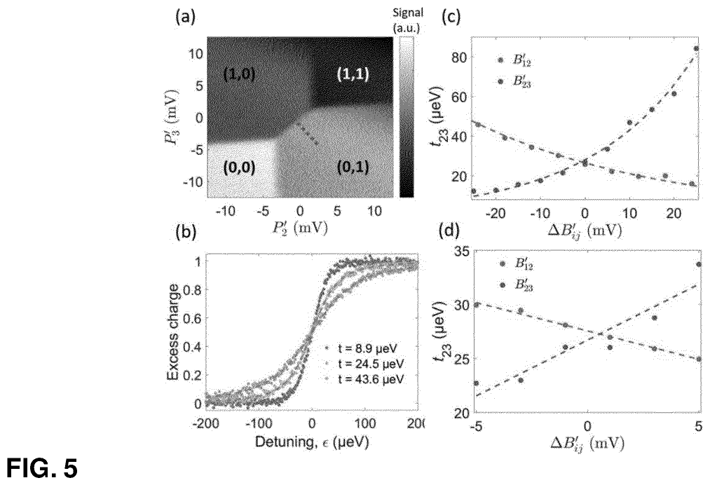

FIG. 5A depicts a charge stability diagram showing sensing-dot signal as a function of voltages on P₂′ and P₃′. Here, the notation (N₂, N₃) indicates charge occupation of dot 2 and 3. The dashed line indicates the axis for detuning. The inter-dot tunnel coupling t₂₃ may be characterized near the (0,1)-(1,0) inter-dot transition by scanning dot potentials along the detuning axis as visualized by a dotted line in FIG. 5A. FIG. 5B depicts the charge extracted from a fit to the sensing-dot signal as a function of the detuning near the inter-dot transition in FIG. 5A.

The gate voltages are converted to dot detuning using lever arms measured with photon-assisted tunnelling. The smooth variation in charge occupation is caused by thermal excitation and charge hybridization via the inter-dot tunnel coupling, and may be fitted to the model of the tunnelling coupling to obtain the value of the tunnel couplings. Utilising this method, an inter-dot tunnel coupling can be measured. The crosstalk of virtual barrier Bₖₗ′, on tunnel coupling tᵢⱼ can be characterized by varying the voltage on Bₖₗ′ and then measuring the change in tᵢⱼ. It is important to use the virtual barrier gate Bₖₗ′ instead of the physical barrier gate Bₖi because varying Bₖₗ′ keeps the dot potentials unchanged so that they remain close to the inter-dot transition. Hence, inter-dot transition scans can be performed subsequently at different Bₖₗ′, without manually adjusting dot potentials.

FIG. 5C depicts the tunnel coupling t₂₃ as a function of virtual barrier voltage B₁₂′ and neighbouring virtual barrier gate B₂₃′, with an exponential fit to the data. Data (colored circles) for different t₂₃ is shown together with the fitted curves (dashed lines). The tunnel coupling t₂₃ may be obtained from a fit to a model of the tunnelling coupling as described in Van Diepen, C. J. et al. Automated tuning of inter-dot tunnel coupling in double quantum dots, Applied Physics Letters 113, 033101 (2018).

As shown in this figure, when virtual gate B₂₃′ becomes more positive, the potential barrier between dots 2 and 3 is lowered so that tunnelling coupling t₂₃ increases exponentially. Increasing virtual gate B₁₂′, however, causes a crosstalk effect which results in an exponentially decreasing tunnel coupling t₂₃. The crosstalk from virtual gate B₁₂′ to tunnel coupling t₂₃ can be understood from the following factors. First, increasing B₁₂′ also increases B₁₂, which capacitively lowers the barrier for t₂₃. Second, in order to keep dot potentials fixed, the voltage on physical gate P₂ is decreased to compensate the crosstalk from the increased voltage on physical gate B₁₂ to the potential of dot 2. Decreasing physical gate P₂ makes the tunnel barrier associated with tunnel coupling t₂₃ higher more than the lowering by B₁₂, resulting in a lowered tunnelling coupling t₂₃. Thirdly, increasing the virtual gate B₁₂′ may shift the wavefunction of the electron in dot 2 away from the electron in dot 3, hence reduce the tunnel coupling. Combining these factors leads to the negative crosstalk of B₁₂′ on t₂₃. Fitting the data in FIG. 5C to an exponential function t₂₃=t₀ exp(Γₖₗ²³Bₖₗ′), results in tunnel coupling crosstalk contributions Γ₁₂²³=−2.31±0.08*10⁻² mV⁻¹, Γ₂₃²³=4.26±0.17*10⁻² mV⁻¹ and an associated tunnel crosstalk ratio r=|Γ₁₂²³/Γ₂₃²³|=54±3%.

The ratio between Γ₁₂²³ and Γ₂₃²³ may be obtained more efficiently using the differential method of FIG. 3, which includes varying virtual gates B₁₂′ and B₂₃′ over a small excitation range and measuring

$$\frac{\partial {t}_{{23}^{′}}}{\partial {B}_{12}^{′}} and \frac{\partial {t}_{{23}^{′}}}{\partial {B}_{23}^{′}}$$

a using a linear fit, which results in

$$\frac{\partial {t}_{{23}^{′}}}{\partial {B}_{12}^{′}} = - 0.53 \pm 0.02 μeV / mV , \frac{\partial {t}_{{23}^{′}}}{\partial {B}_{23}^{′}} = 1.03 \pm 0.18 μeV / mV$$

and a tunnel coupling crosstalk ratio

$${r}^{′} = \vert \frac{\partial {t}_{{23}^{′}}}{\partial {B}_{12}^{′}} / \frac{\partial {t}_{{23}^{′}}}{\partial {B}_{23}^{′}} \vert = 51 \pm 9 \% .$$

From equation (2), it can be determined that

$${Γ}_{12}^{23} / {Γ}_{23}^{23} = \frac{\partial {t}_{{23}^{′}}}{\partial {B}_{12}^{′}} / \frac{\partial {t}_{{23}^{′}}}{\partial {B}_{23}^{′}} ,$$

which is confirmed by the similar ratios r and r′ from the two different measurements in FIGS. 5C and 5D. This result indicates that it is indeed sufficient to measure the derivative of a tunnel coupling with respect to B′ to efficiently characterize the ratios between Γ, which are used for defining the enhanced virtual gates B^{†}.

Here, the factors Λ for P′ in equation (2) are not characterize. To stay near the inter-dot transition, two neighbouring virtual gates Pᵢ′ and Pⱼ′ need to be varied together, therefore Λᵢ^{ij} and Λⱼ^{ij} cannot be independently measured. However, this does not affect the orthogonal control of tunnel coupling tᵢⱼ using virtual gate Bᵢⱼ^{†}. In fact, the linear combination of gate voltages needed to orthogonally change B^{†} is independent of Δ.

The crosstalk calibration and the orthogonal control of inter-dot tunnel couplings of the quantum dot array of FIG. 1 may be determined using the above-described tunnel coupling calibration method. The capacitive coupling to dot potentials may be characterized for an arbitrary condition, where t₁₂=35 μeV, t₂₃=23 μeV and t₃₄=26 μeV and gates P′B′ may be defined in terms of physical gates B, P using the dot potential crosstalk matrix C as defined by equation (1), The quantum dot array may then tuned to the (1,0,1,1)-(0,1,1,1) inter-dot transition to measure t₁₂, where (N₁,N₂,N₃,N₄) indicates the charge occupation from dot 1 to dot 4.

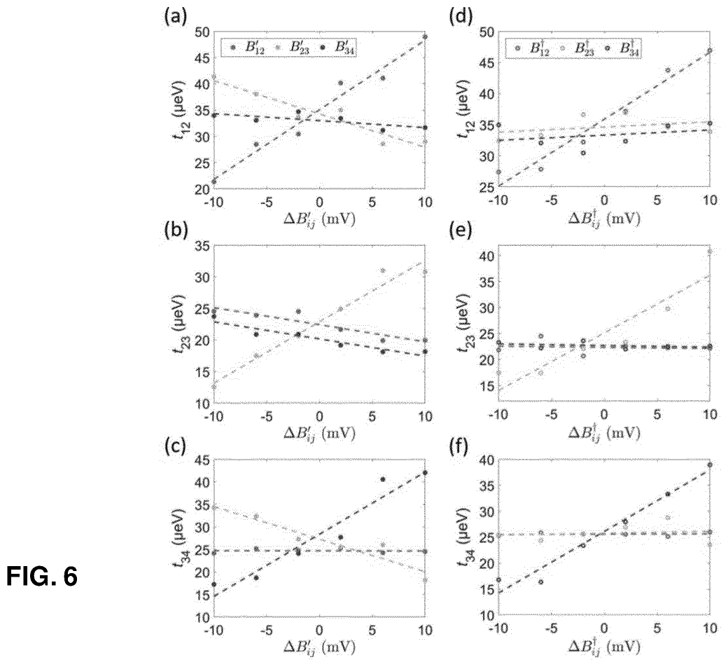

The dependence of tunnel coupling t₁₂ on the virtual gates B′ is shown in FIG. 6A. As expected, t₁₂ shows the largest dependence on the corresponding barrier B₁₂′. Further, based on the differential method described above one may determine that

$$\frac{\partial {t}_{12}}{\partial {B}_{12}^{′}} = 1.32 μeV / mV ,$$

t₁₂=35 μeV/mV, Γ₁₂¹²=3.77*10⁻² mV⁻¹. Changing virtual gate B₂₃′ has a negative crosstalk effect on t₁₂ of about 50% compared with the effect from B₁₂′. The crosstalk effect due to virtual gate B₃₄′ is weaker (˜10%), which is expected, because this gate is positioned B₃₄′ further away from B₁₂′ than B₂₃′. The crosstalk on t₂₃ and t₃₄ is also characterized by tuning the quadruple dot to (1,1,0,1)-(1,0,1,1) and (1,1,1,0)-(1,1,0,1) transitions, respectively.

FIG. 6B, t₂₃ shows the largest dependence on virtual gate B₂₃′ wherein Γ₂₃²³=4.18*10⁻² mV⁻¹. The crosstalk of B₁₂′ and B₃₄′ on t₂₃ is about 30%. In FIG. 6C, t₃₄ shows the largest dependence on virtual gate B₃₄′ wherein Γ₃₄³⁴=5.39*10⁻² mV⁻¹. The crosstalk of B₂₃′ on t₃₄ is about 50% and the crosstalk of B₁₂′ is <1.

To achieve orthogonal control of tunnel couplings, the characterized crosstalk may be arranged into the tunnel coupling crosstalk matrix T as described with reference to equation (3), which give the relation between B^{†} and B′. Note that an additional crosstalk characterization may be carried out to further eliminate the residual crosstalk. The dot potential crosstalk matrix C and the tunnel coupling crosstalk matrix T may be combined into an overall crosstalk matrix which relates the enhanced virtual gates B^{†}, P^{†} directly to the physical gate voltages P,B. The inverse of this matrix allows each enhanced virtual gate to be written in a linear combination of physical gates.

FIG. 6D-6F show the measured tunnel couplings as a function of the enhanced virtual gates B^{†}. Each tunnelling coupling tᵢⱼ is only affected by the respective enhanced virtual gate Bᵢⱼ^{†} and crosstalk of other enhanced virtual gates B^{†} is significantly suppressed (<8. This results shows that the enhanced virtual gates B^{†} orthogonally control the tunnel couplings in the quantum dot array. Based on the enhanced virtual gates B^{†}, the quantum dot array can be quickly tuned to a desired configuration, for example, t₁₂=t₂₃=t₃₄.

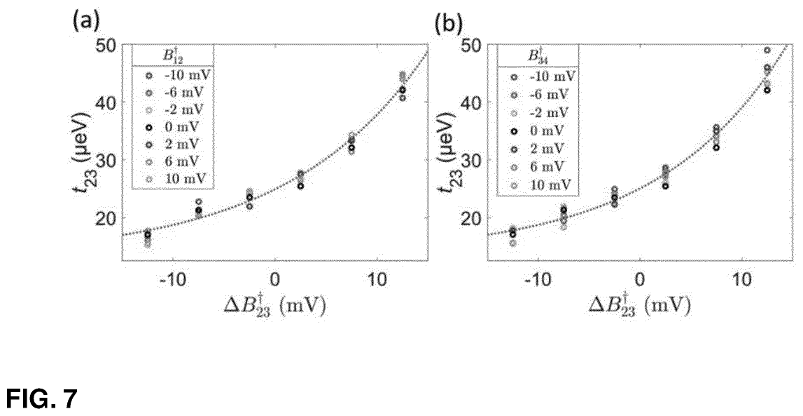

In order to show that the enhanced virtual gates B^{†} compensate for crosstalk despite the exponential dependence of the tunnelling coupling as described by equation (2), B^{†} may first be calibrated when the tunnel coupling is set to t₂₃=25 μeV, and then the crosstalk effect on the tunnelling coupling t₂₃ on B₂₃^{†} is measured for different values of enhanced virtual gates B₁₂^{†} and B₂₃^{†}. FIGS. 7A and 7B show tunnel coupling element t₂₃ as a function of ΔB₂₃^{†} for different ΔB₁₂^{†} and ΔB₃₄^{†} respectively, plotted with the exponential fit to the data. ΔBᵢⱼ^{†} is the voltage relative to Bᵢⱼ^{†} when tᵢⱼ˜25 μeV. These figures show that changing the enhanced virtual gate B₃ by 25 mV exponentially increases the tunnel coupling t₂₃ by 27 μeV. Further, these figures show that varying the enhanced virtual gates B₁₂^{†} and B₃₄^{†} by 20 mV only has a minor effect on the tunnel coupling t₂₃ (crosstalk <10% except for B₂₃^{†}=−7.5 and −12.5 mV, where the small

$$\frac{\partial {t}_{23}}{\partial {B}_{23}^{†}}$$

results in a higher cross-talk ratio due to uncertainty of the linear fit).

These results show that the orthogonal control of tunnel couplings based on the enhanced virtual gate B^{†} works for a large range of different settings even though the calibration was done for a particular setting t₂₃=25 μeV. This can be explained by the fact that the enhanced virtual gate B^{†} actually compensates for the crosstalk factors in the exponent Φ (see equation (2)) rather than just compensate for linearized the dependence of tunnel couplings in a small range of gate voltages. As long as the crosstalk factors r for the virtual gates B′ do not change, orthogonal control of tunnel couplings using B^{†} is effective for a large range of tunnel coupling values.

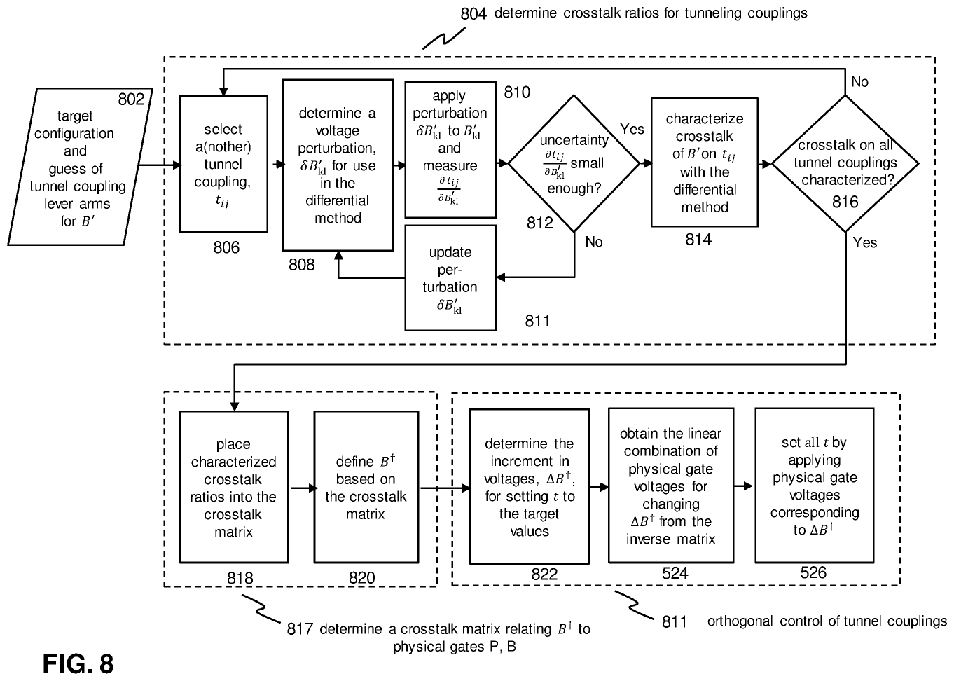

FIG. 8 depicts a flow diagram of a method of controlling tunnel couplings in a quantum dot array according to an embodiment of the invention. The method may start with a step of determining a target configuration of tunnel couplings, e.g. a target configuration defining target values of tunnel couplings between one or more pairs of quantum dots in a quantum dot array. Here, the target configuration may be associated with a certain step in a quantum computing simulation process. Further, virtual barrier voltages B′ (step 802) may be determined for an initial estimate of the target values. Thereafter, the cross-capacitance contributions for the tunnel couplings may be determined (step 804). These cross-capacitance contributions may include values describing the crosstalk of a virtual gate voltage on tunnel couplings of pairs of quantum dots in the quantum dot array.

As shown in FIG. 8, the determining of the cross-capacitance contributions may include: selecting a tunnel barrier associated with a tunnel coupling tᵢⱼ between a quantum dot i and a quantum dot j (step 806). Further, the determining may include a step 808 of determining a voltage perturbation, δBₖₗ′ that may be used for determining crosstalk ratios for tunnel coupling tᵢⱼ and virtual gate Bₖₗ′ (step 808) based on the first cross-capacitance contributions of physical gates B, P as described with reference to FIG. 3. This voltage perturbation may be used to drive gate voltage Bₖₗ′, over a small voltage range δBₖₗ′ and to measure the derivative

$$\frac{\partial {t}_{ij}}{δ {B}_{k l}^{′}}$$

(step 810). If the response signal is strong enough, i.e. the error in the derivative

$$\frac{\partial {t}_{ij}}{δ {B}_{k l}^{′}}$$

is small enough, (step 812), then the perturbation δBₖₗ′ may be used for determining the cross-capacitance contributions for the tunnel couplings (step 814). If not, the perturbation δBₖₗ′ may be updated (step 811) and the updated perturbation may be used to determine a new crosstalk ratio according to steps 810 and 812. This process may be repeated until the crosstalk ratios for all tunnel couplings are determined (step 816).

If the crosstalk due to the gate voltages on all tunnel couplings is characterized, the tunnel coupling crosstalk matrix T may be constructed (step 817). This, step may include determine the crosstalk ratios and place the crosstalk ratio's in the matrix (step 818). Then, based on this matrix enhanced virtual gates {P^{†},B^{†} } may be defined as a linear combination of the virtual gates B′, P′ (steps 820).

Thereafter, the tunnelling couplings of the quantum dot array can be orthogonally controlled (step 821). For example, for each enhanced virtual gate a voltage increments ΔB^{†} for the enhanced virtual gates may be determined to set the tunnel couplings to the target values (step 822). Further, based on the inverse of the tunnel coupling crosstalk matrix and the dot potential matrix, a linear combination of physical gate voltages may be obtained (step 824) and are used to achieve the voltage increments ΔB^{†} for the enhanced virtual gates (step 826). Thus, in the scheme of FIG. 8, first all crosstalk contributions are determined and then based on the crosstalk contributions the enhanced virtual gate may be defined to orthogonally control the tunnelling couplings in the quantum dot array.

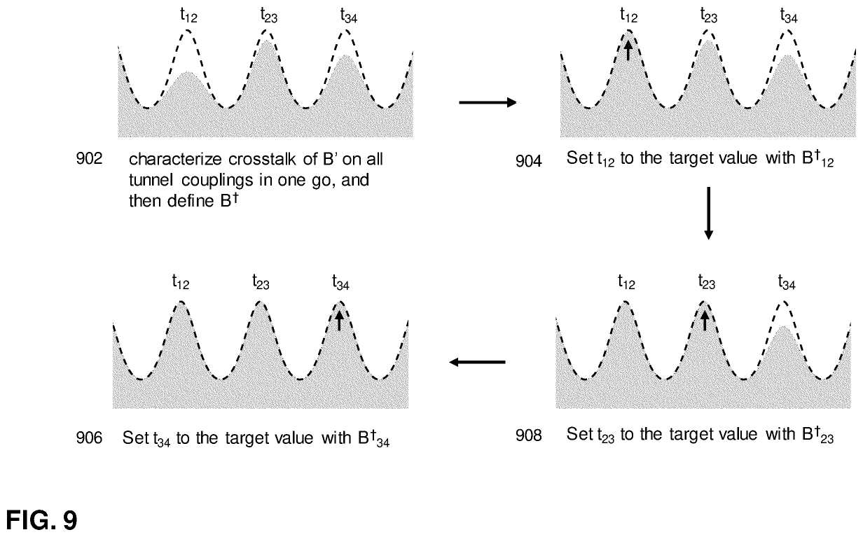

FIG. 9 illustrates part of the calibration scheme for controlling tunnel couplings in a quantum dot array. As shown in this figure, crosstalk contributions of virtual gates B′ on all tunnelling couplings are determined in one go and based on this crosstalk contributions the enhanced virtual gates B^{†} may be defined (step 902). Based on these enhanced gates, each tunnel coupling element tᵢⱼ can be set to a target value (step 904-908). This way all tunnelling couplings can be set to a target value.

In the tunnelling coupling control methods described with reference to FIGS. 8 and 9 first the crosstalk on every tunnel coupling is characterized, and then the enhanced virtual gates B^{†} are defined that allow orthogonal tuning of all of the tunnel couplings to target values. However, if some of the tunnel couplings in the initial configuration are small, the crosstalk ratio obtained using the method will have a larger error because

$$\frac{\partial {t}_{ij}}{\partial {B}_{k l}^{′}} ∝ {t}_{ij}$$

and the error in measuring tᵢⱼ is roughly 1 μeV. In addition, the issue of crosstalk comes back if one wants to use virtual gate B′ to tune all tunnel couplings to be large enough (>20 μeV in the present examples).

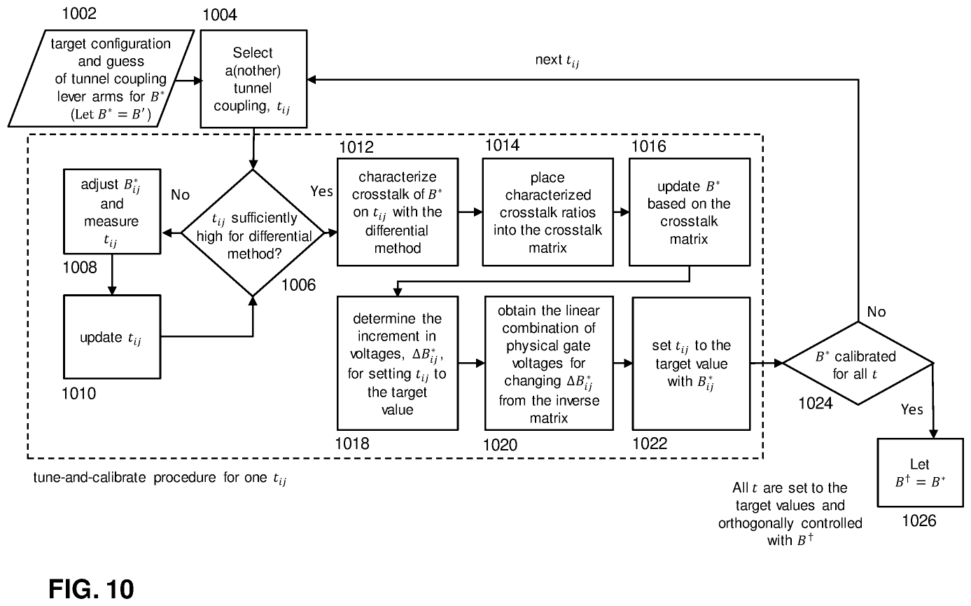

FIG. 10 depicts orthogonal control of tunnel couplings according to another embodiment of the invention. In particular, the figure depicts a flow diagram of a crosstalk calibration method for the tunnel couplings in a quantum dot array which addresses the above-mentioned problem of initial configurations that include small tunnel couplings. The method defines a so-called stepwise tune-and-calibrate procedure. This procedure may be used to set the tunnel couplings in a large-scale quantum dot array from an arbitrary initial configuration to a target configuration and achieving orthogonal control at the same time.

The method may start with a step of determining a target configuration of tunnel couplings, e.g. a target configuration associated with a certain step in a quantum computation or simulation process. Further, an initial estimate for the lever arms for virtual barrier voltages B′ (step 1002) may be determined. Then, a tunneling coupling may be selected (step 1004). This tunnel coupling tᵢⱼ may be chosen e.g. randomly, as the first inter-dot tunnel coupling to tune and calibrate.

First the selected tunneling coupling tᵢⱼ may be measured and tested if its value is sufficiently high for determining the crosstalk on tᵢⱼ using the differential method. If this is not the case, tᵢⱼ may be updated by using virtual gate Bᵢⱼ′ to tune tᵢⱼ above a threshold value, for example larger than 20 μeV, at which the crosstalk on tᵢⱼ can be accurately obtained using the differential method tuning its above. Preferably, virtual gate Bᵢⱼ′ may be used to tune tᵢⱼ to a target value. If tᵢⱼ is sufficiently high, crosstalk contributions of virtual gates B′ on tᵢⱼ may be measured using the differential method (step 1012). The measured crosstalk contributions may be used to determine crosstalk ratios of a crosstalk matrix (step 1014), which defines intermediate virtual gates in terms of virtual gates B′.

Based on the crosstalk matrix first intermediate virtual gates B* may be defined which are configured to compensate for crosstalk on tᵢⱼ(step 1016). Thereafter, a voltage value ΔBᵢⱼ* may be determined for tuning tᵢⱼ towards the target value using first intermediate virtual gate Bᵢⱼ* (step 1018). Then, based on the inverse of the crosstalk matrix a linear combination of physical gate voltages may be determined to tune intermediate virtual gate Bᵢⱼ* based on voltage value ΔBᵢⱼ* (step 1020) so that tunnel coupling tᵢⱼ is set to the target value (step 1022). Thereafter, the next tunnel coupling may be process.

This process may be repeated for all tunnel couplings tᵢⱼ in the array (step 1024). For example, in a next iteration a further tunnel coupling, tₖₗ of the quantum dot array may be selected and if that value is not sufficiently high for the differential method, tₖₗ may be updated (according to steps 1006-1010). For example, a first intermediate virtual gate Bₖₗ^{*1} may be used to tune tunnel coupling tₖₗ above the characterization threshold without affecting tunnel coupling tᵢⱼ because the first intermediate gates Bₖₗ^{*1} compensate for the crosstalk on tᵢⱼ.

Then, the crosstalk of B^{*1} on tₖₗ may be determined based on the differential method (step 1012) and the crosstalk matrix may be updated on the basis of the cross-capacitance contributions that are derived from the differential method (step 1014). The differential method may be similar to the steps 808-814 of FIG. 8. The differential method may include at least the application of a voltage perturbation δBₘₙ^{*1} to intermediate virtual gate Bₘₙ^{*1} and measure the ratio

$$\frac{\partial {t}_{k l}}{\partial {B}_{mn}^{* 1}}$$

of a change in the tunnel coupling and the voltage perturbation of δB^{*1}.

The updated crosstalk matrix may then be used to define second intermediate virtual gates B^{*2}, which are configured to compensate for the crosstalk on tᵢⱼ and tₖₗ (according to step 1016) If tunnel coupling tₖₗ is not yet the desired value, than tₖₗ may be tuned to the target value using its associated second intermediate tunnel gate Bₖₗ^{*2}.

Hence, for each subsequent tᵢⱼ the intermediate virtual gates B* and the crosstalk matrix are updated to incorporate the crosstalk compensation for the tuned tunnel couplings tᵢⱼ. The intermediate virtual gates B*define the enhanced virtual gates B^{†} once all tunnel couplings tᵢⱼ are calibrated (step 1026),

Hence, in contrast to the procedure of FIGS. 8 and 9, a first tunnel coupling tᵢⱼ is tuned to a target value using virtual gate Bᵢⱼ′. Thereafter, the crosstalk of virtual gates B′ on tunnel coupling tᵢⱼ are characterized, and intermediate virtual gates B*, which only compensate for the crosstalk on tᵢⱼ, are defined. Thereafter, an intermediate virtual gate B* (which compensates for crosstalk on tᵢⱼ) is used to tune a second (nearby) tunnel coupling tₖₗ to a target value without affecting the tuned tunnel coupling tᵢⱼ. Next, by calibrating the crosstalk on tₖₗ, the intermediate virtual gates B* may be updated to include crosstalk compensation for tunnel coupling tₖₗ. Repeating the procedure for each tunnel barrier, tunnel couplings can be tuned one-by-one to desired target values and enhanced virtual gates care obtained to orthogonally control the gates.

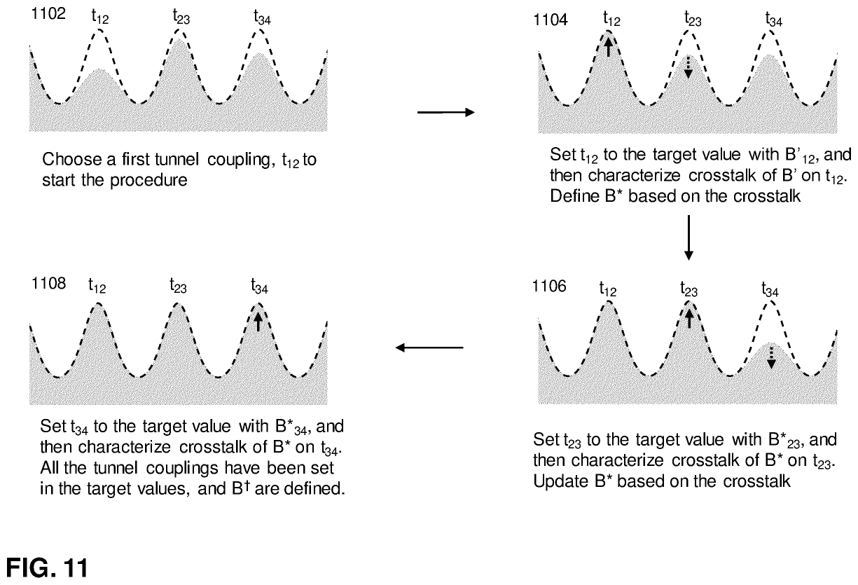

FIG. 11 illustrates setting tunnel couplings to target values based on enhanced virtual gates according to another embodiment of the invention. A first tunnel coupling t₁₂ may be selected to start the calibration procedure, wherein tunnel coupling t₁₂ is set to the target value using virtual gate B₁₂ and then the crosstalk of virtual gates B′ on t₁₂ is determined. Thereafter, intermediate virtual gates B* may be defined based on the determined crosstalk. This process may be repeated for t₂₃ and t₃₄ so that all tunnel couplings have been set to the target values and enhanced virtual gates B^{†} are defined that allow orthogonal control of the tunnel couplings.

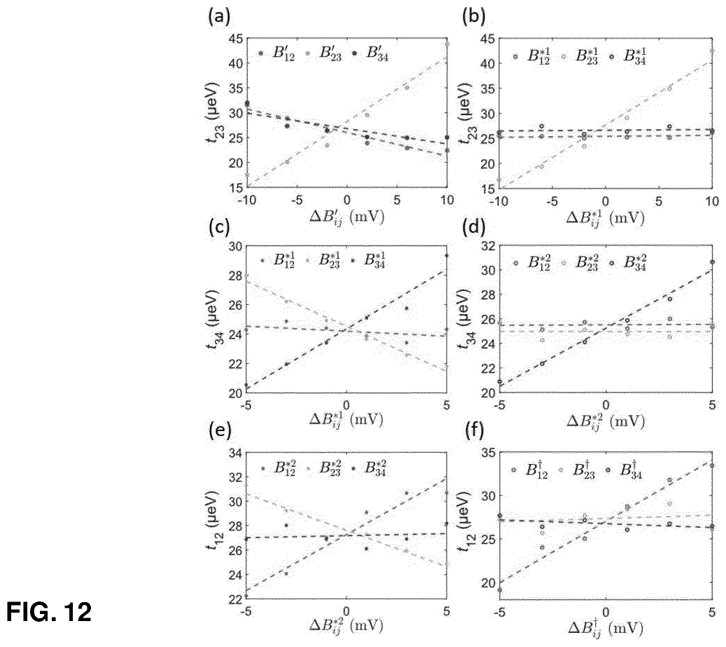

FIG. 12A-12F illustrate experimental data illustrating orthogonal control of tunnel couplings according to an embodiment of the invention. In particular, the experimental data depicted in the figures are associated with tunnel coupling control procedure wherein tunnel couplings of a quantum dot array may be tuned from an arbitrary initial configuration to a target configuration, for example, as target configuration wherein all of the tunnel couplings are tuned to ˜25 μeV. Further, the arbitrary initial condition of the tunnel couplings may be (t₁₂, t₂₃, t₃₄)=(6.1,25.9,8.8) (in μeV).

Then, after defining virtual gates P′, B′ based on dot potential cross-capacitance contributions as described with reference to equation (1), the procedure may select a first tunnel coupling t₂₃ to start the tuning and calibration process.

FIG. 12A shows the crosstalk of the virtual gates B′ on tunnel coupling t₂₃. Based on the characterized crosstalk, a first tunnel coupling crosstalk matrix may define the relation between intermediate virtual gates B^{*1} and virtual gates B′, wherein intermediate virtual gates B^{*1} are configured to compensate for crosstalk on t₂₃:

$$( \begin{matrix}{B}_{12}^{* 1} \\ {B}_{23}^{* 1} \\ {B}_{34}^{* 1}\end{matrix} ) = ( \begin{matrix}1 & 0 & 0 \\ - 0.36 & 1 & - 0.24 \\ 0 & 0 & 1\end{matrix} ) ( \begin{matrix}{B}_{12}^{′} \\ {B}_{23}^{′} \\ {B}_{34}^{′}\end{matrix} )$$

As shown in FIG. 12B, the crosstalk on t₂₃ by the first intermediate virtual gates B^{*1} is below 2%, showing that the crosstalk compensation on t₂₃ for the first intermediate virtual gates works well.

Subsequently, a second tunneling coupling t₃₄ may be tuned to 24.7 μeV using the associated first intermediate virtual gate B₃₄^{*1} (ΔB₃₄^{*1}=105 mV). Since first intermediate virtual gate B₃₄^{*1} includes the compensation for crosstalk on the tuned tunneling coupling t₂₃, changing this first intermediate virtual gate B₃₄^{*1} by 105 mV only affects tunneling coupling t₂₃ by 0.7 μeV (from 25.9 μeV to 26.6 μeV). Thus, tunnel coupling t₃₄ can be tuned using its associated first intermediate virtual gate B₃₄^{*1} without affecting the already tuned tunnel coupling t₂₃.

FIG. 12C shows the crosstalk of the virtual gates B^{*1} on tunneling coupling t₃₄. A first updated crosstalk matrix may be defined by multiplying a second crosstalk matrix describing the crosstalk of the first intermediate virtual gate B^{*1} on t₃₄ with the first crosstalk matrix and then normalizing each row so that the diagonal elements are one. The first updated crosstalk matrix may be used to define second intermediate virtual gates B^{*2} which are configured to compensate for the crosstalk on the tuned tunneling couplings t₂₃ and t₃₄. The first updated crosstalk matrix defines the relation between the second intermediate virtual gates B^{*2} and the virtual gates B′:

$$( \begin{matrix}{B}_{12}^{* 2} \\ {B}_{23}^{* 2} \\ {B}_{34}^{* 2}\end{matrix} ) = ( \begin{matrix}1 & 0 & 0 \\ - 0.36 & 1 & - 0.24 \\ 0.23 & - 0.64 & 1\end{matrix} ) ( \begin{matrix}{B}_{12}^{′} \\ {B}_{23}^{′} \\ {B}_{34}^{′}\end{matrix} )$$

As shown in FIG. 12D, when using the second intermediate virtual gates B^{*2}, the crosstalk on the tuned tunnel coupling t₂₃ and t₃₄ are suppressed to below 1%.

Finally, the third tunnel coupling t₁₂ may be tuned to 27.7 μeV using second intermediate virtual gate B₁₂^{*2} (ΔB₁₂^{*2}=100 mV). Again, since second intermediate virtual gate B₁₂^{*2} includes the compensation for crosstalk on tuned tunnel coupling t₂₃ as well, changing second intermediate virtual gate B₁₂^{*2} by 100 mV only affects t₂₃ by 2.4 μeV (from 26.6 μeV to 24.2 μeV).

FIG. 12E shows the crosstalk of the virtual gates B^{*2} on tunneling coupling t₁₂. A second updated crosstalk matrix may be determined by multiplying a third crosstalk matrix describing the crosstalk of the second intermediate virtual gate B^{*2} on t₁₂ with the first updated crosstalk matrix and then normalizing each row so that the diagonal elements are one. This second updated crosstalk matrix may define the relation between the enhanced virtual gates B^{†} and virtual gates B′ which now includes compensation for the crosstalk on all the tunnel couplings:

$$( \begin{matrix}{B}_{12}^{†} \\ {B}_{23}^{†} \\ {B}_{34}^{†}\end{matrix} ) = ( \begin{matrix}1 & - 0.84 & 0.2 \\ - 0.36 & 1 & - 0.24 \\ 0.23 & - 0.64 & 1\end{matrix} ) ( \begin{matrix}{B}_{12}^{′} \\ {B}_{23}^{′} \\ {B}_{34}^{′}\end{matrix} )$$

As shown in FIG. 12F, when using the enhanced virtual gates B^{†}, the crosstalk on tunnel coupling t₁₂ is reduced to below 6%.

Based on the above-described tune and calibrate steps, the tunnel couplings have been tuned from an initial configuration where (t₁₂, t₂₃, t₃₄)=(6.1,25.9,8.8) to (27.7,24.2,24.7), which is close to the target (25,25,25). The tune-and-calibrate procedure thus allows an arbitrary initial condition to be tuned to a target condition. Moreover, the enhanced virtual gates B^{†} include the compensation for the cross-talk on all the tunnel couplings, so one can in principle use B^{†} to orthogonally tune the tunnel couplings to other configurations provided that the crosstalk ratios remain substantially the same.

Crosstalk factors Λ for P^{†} since Λᵢ^{ij} and Λⱼ^{ij} cannot be independently measured using our method. Hence, varying P^{†} would affect tunnel couplings. To perform a complete crosstalk calibration, one may measure the exchange coupling, Jᵢⱼ, as a function of Pᵢ′ and Pⱼ′ independently using a spin-funnel as described in the article by Petta, J. R. et al, Coherent manipulation of coupled electron spins in semiconductor quantum dots, Science 309, 2180-2184(2005) or photon-assisted tunnel as described by Oosterkamp. T. H. et al., Microwave spectroscopy of a quantum-dot molecule, Nature 395, 873 (1998), and then obtain tᵢⱼ from Jᵢⱼ. By doing so, all the nonzero elements in the cross-capacitance matrix in equation (3) may be obtained, which will make the tuning of dot potentials and tunnel couplings fully orthogonal.

It is submitted that the quantum dot array depicted in the figures of this application are is just an example of an array that can be used with the embodiments described in this application. The embodiments described in this application may be implemented on the basis of any type of gated quantum dot array architecture, including 1D, 2D or 3D quantum dot arrays.

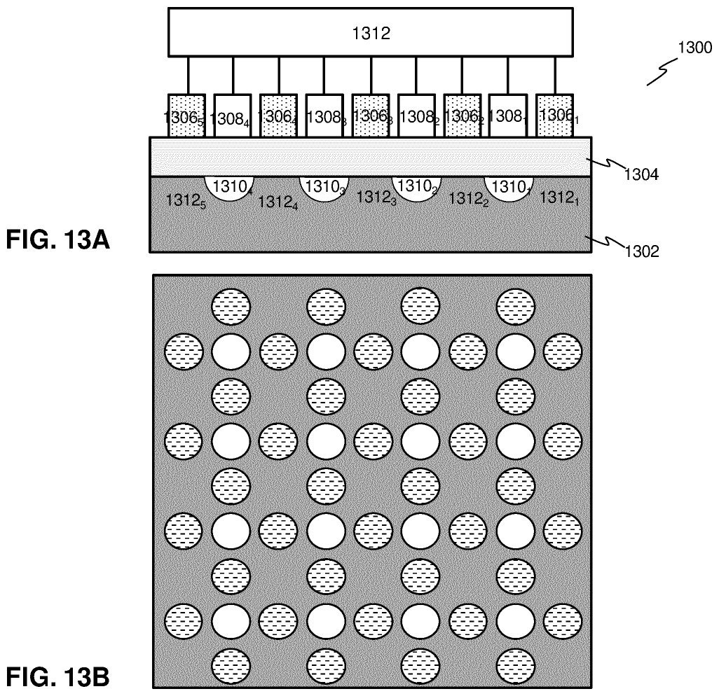

FIGS. 13A and 13B depict the side view and top view of a system comprising two-dimensional quantum-dot array 1300 connected to electronics 1312, e.g. a computer or a controller, for executing the readout schemes as described in this application. In particular, FIG. 13A depicts the side view of a semiconducting structure, including a semiconductor substrate 1302. An insulating layer 1304 formed over the top surface of the substrate isolates gates from quantum dot regions 1310, which are formed in the substrate. The quantum dots may be any type of structure suitable for functioning as a quantum dot, a donor site, a depleted 2D, etc. The potential of the quantum dots may be controlled by plunger gates 1308₁₋₄ and the tunnel couplings between dots are controlled by the barrier gates 1306₁₋₅. The plunger and barrier gates are patterned so that a two-dimensional quantum-dot array can be formed by applying voltages to these gates. For example, in case of the substrate includes a 2DEG heterostructure, the voltages on the gates may deplete the 2DEG and shape the 2DEG in to a 2D quantum-dot array. This way, as shown in FIG. 13B, a regular 2D array of quantum dots may be formed under the plunger gates and tunneling barriers between the quantum dots may be formed under the barrier gates.

Other types of 2D quantum dot array architectures may be used as well, for example, the cross-bar design 2D quantum dot arrays as described in the article by Ruoyu Li et al, A crossbar network for silicon quantum dot qubits, Science Advances, Vol. 4,no. 7, 2018. In this architectures. A plurality of quantum dots may be controlled by one gate electrode. Hence, in an embodiment, one physical gate of a quantum dot may be configured to control a coupling, a tunnel coupling, an exchange coupling or a capacitive coupling of a plurality quantum dots and/or a dot potential of a plurality of quantum dots. Similarly, the virtual gates, the intermediate virtual gates and the enhanced virtual gates described with reference to the embodiments in this application may be configured to control a coupling of a plurality of quantum dots, while compensating at least part of the crosstalk due cross-capacitances in the quantum dot array.

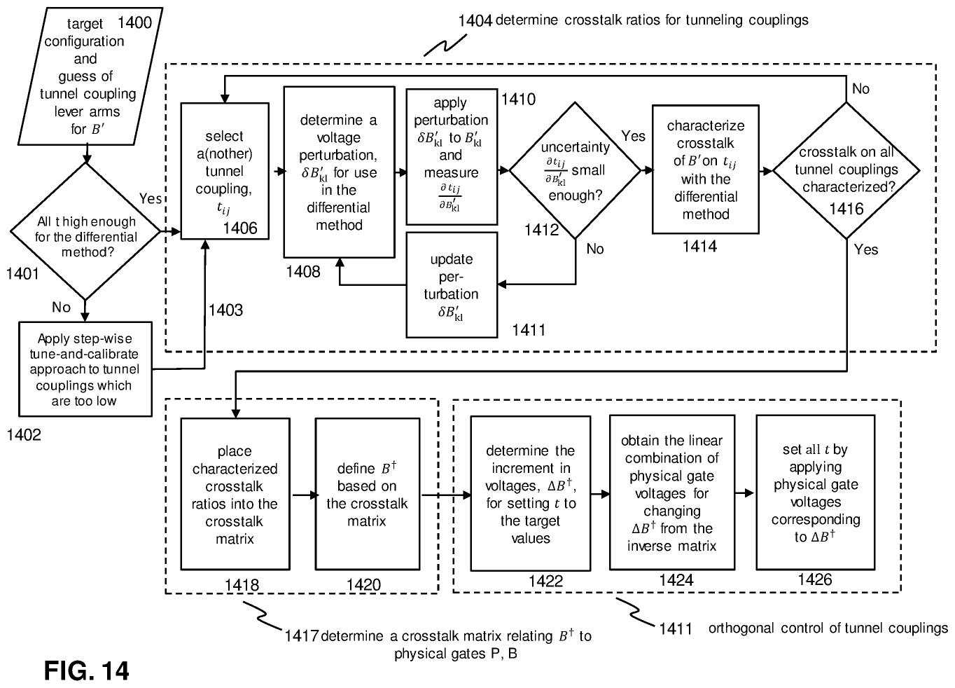

FIG. 14 depicts orthogonal control of tunnel couplings according to another embodiment of the invention. In this embodiment, a combination of the control scheme of FIG. 8 and FIG. 10 may be used. The method may start with a step of determining a target configuration of tunnel couplings, e.g. a target configuration associated with a certain step in a quantum computation or simulation process. Further, an initial estimate for the lever arms for virtual barrier voltages B′ (step 1400) may be determined. Then, the tunnel couplings may be measured and checked if the values are sufficiently high enough for determining crosstalk ratios based on the differential method. For example, it may be checked if the values of the tunneling couplings are above or below a certain threshold value (step 1401). If the values are high enough, then the crosstalk ratios for the tunneling couplings and subsequent enhanced virtual gates may be determined based on the scheme of steps 1404-1426, which are identical to steps 804-826 of FIG. 8 (representing the crosstalk calibration method in one go).

If some of the tunnel couplings are not sufficiently high (below a certain threshold), these values may be tuned and calibrated using the scheme described with reference to FIG. 10 (representing the step-wise tune-and-calibrate method). Once these tunnel values are tuned and calibrated, the calibration process may continue based on the scheme defined by steps 1404-1426, the one-go calibration method.

While the schemes of FIGS. 4-12 and 14 are described for controlling tunnel couplings in quantum dots it is submitted that other types of couplings such as co-tunnelling coupling, exchange coupling and/or a capacitive coupling can be controlled as well based on the embodiments described in this application.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A computer-implemented method of controlling coupling of at least two quantum dots in a quantum dot array, the method comprising:
determining dot potential crosstalk ratios of physical gates coupling to dot potentials of quantum dots in the quantum dot array, the dot potential crosstalk ratios defining a dot potential crosstalk matrix, an inverse of the dot potential crosstalk matrix defining virtual gates as a linear combination of the physical gates for orthogonal control of the dot potentials, wherein determining the dot potential crosstalk ratios comprises: controlling a controller of the quantum dot array to apply a voltage to one of the physical gates and to measure cross-talk effects of the applied voltage to the dot potentials of the quantum dots and calculating the ratios between cross-talk effects from different ones of said physical gates;
determining coupling crosstalk ratios of virtual gates coupling to dot couplings between one or more pairs of the quantum dots in the quantum dot array, the coupling crosstalk ratios defining elements of a coupling crosstalk matrix, an inverse of the coupling crosstalk matrix defining enhanced virtual gates as a linear combination of the virtual gates for orthogonal control of the dot couplings; wherein the coupling crosstalk ratios are determined based on ratios of partial derivatives of the dot couplings between pairs of the quantum dots in the quantum dot array with respect to virtual gate voltages, determining of one said partial derivative including: controlling the controller to apply a voltage perturbation to at least one of the virtual gates, while keeping voltages on other of said virtual gates constant and, in response to the voltage perturbation, measuring a change of the dot coupling of one said pair of the quantum dots and fitting the change of the dot coupling to a linear function; and
controlling the controller based on the enhanced virtual gates, the controlling including using at least one of the enhanced virtual gates for applying a linear combination of gate voltages to the physical gates to tune the coupling of the at least two quantum dots to a target value.

2. The method according to claim 1 wherein the dot coupling between one or more of said pairs of quantum dots is modelled as a single-variable function in which the single variable is a linear combination of the virtual gates.

3. The method according to claim 1, wherein the virtual gates include one or more virtual barrier gates for controlling the couplings of quantum dots in the quantum dot array; and/or the virtual gates include one or more virtual plunger gates for controlling the dot potentials of one or more of said quantum dots in the array of quantum dots.

4. The method according to claim 1, wherein the dot coupling of the at least two quantum dots is at least one of: a tunnel coupling, a co-tunnelling coupling, an exchange coupling and/or a capacitive coupling.

5. The method according to claim 1, wherein the method further comprises:
determining a combined crosstalk matrix based on the dot potential crosstalk matrix and the coupling crosstalk matrix, an inverse of the combined crosstalk matrix defining enhanced virtual gates as a linear combination of physical gate voltages for orthogonal control of the couplings of the quantum dots in the quantum dot array.

6. The method according to claim 5 wherein controlling the coupling further comprises:
determining a linear combination of the physical gate voltages based on the inverse of the combined crosstalk matrix.

7. The method according to claim 1, wherein controlling the coupling further comprises:
determining the inverse of the dot potential crosstalk matrix;
determining the inverse of the coupling crosstalk matrix; and,
determining a linear combination of physical gate voltages to control the dot coupling of the at least two quantum dots based on the inverse of the coupling crosstalk matrix and the inverse of the dot potential crosstalk matrix.

8. The method according to claim 1, wherein the array of quantum dots is a one-dimensional array of quantum dots or a two-dimensional array of quantum dots.

9. A computer for controlling a controller connectable to an array of quantum dots for controlling a coupling of at least two of said quantum dots in the array of quantum dots, the computer being configured to:
determine dot potential crosstalk ratios of physical gates coupling to dot potentials of the quantum dots in the quantum dot array, the dot potential crosstalk ratios defining a dot potential crosstalk matrix, an inverse of the dot potential crosstalk matrix defining virtual gates as a linear combination of the physical gates for orthogonal control of the dot potentials, wherein determining the dot potential crosstalk ratios comprises: controlling the controller to apply a voltage to one of the physical gates and measuring cross-talk effects of the applied voltage to the dot potentials of the quantum dots and calculate the ratios between the cross-talk effects from different of said physical gates;
determine coupling crosstalk ratios of virtual gates coupling to dot couplings between one or more pairs of the quantum dots in the quantum dot array, the coupling crosstalk ratios defining elements of a coupling crosstalk matrix, an inverse of the coupling crosstalk matrix defining enhanced virtual gates as a linear combination of the virtual gates for orthogonal control of the dot couplings; wherein the coupling crosstalk ratios are determined based on ratios of partial derivatives of the dot couplings between pairs of the quantum dots in the quantum dot array with respect to virtual gate voltages, determining of one said partial derivative including: controlling the controller to apply a voltage perturbation to at least one of the virtual gates, while keeping voltages on other of said virtual gates constant and, in response to the voltage perturbation, measuring a change of the dot coupling of one said pair of the quantum dots and fitting the change of the dot coupling to a linear function; and
controlling the controller based on the enhanced virtual gates, the controlling including using at least one of the enhanced virtual gates for applying a linear combination of gate voltages to the physical gates to tune the coupling of the at least two quantum dots to a target value.

10. The computer according to claim 9 wherein the dot coupling between one or more of said pairs of quantum dots is modelled as a single-variable function in which the single variable is a linear combination of the virtual gates.

11. The computer according to claim 9, wherein the virtual gates include one or more virtual barrier gates for controlling couplings of quantum dots in the quantum dot array; and/or the virtual gates include one or more virtual plunger gates for controlling the dot potentials of one or more of said quantum dots in the array of quantum dots.

12. The computer according to claim 9, wherein the coupling of the at least two quantum dots is at least one of: a tunnel coupling, a co-tunnelling coupling, an exchange coupling parameter and/or a capacitive coupling.

13. The computer according to claim 9, wherein the computer is further configured to:
determine a combined crosstalk matrix based on the dot potential crosstalk matrix and the coupling crosstalk matrix, an inverse of the combined crosstalk matrix defining enhanced virtual gates as a linear combination of physical gate voltages for orthogonal control of the couplings of the quantum dots in the quantum dot array.

14. The computer according claim 9, wherein controlling the coupling further comprises:
determining the inverse of the dot potential crosstalk matrix;
determining an inverse of the coupling crosstalk matrix; and,
determining a linear combination of physical gate voltages to control the dot coupling of the at least two quantum dots based on the inverse of the coupling crosstalk and the inverse of the dot potential crosstalk matrix.

15. A computer program product comprising software code portions configured for, when run in a memory of a computer, executing the method steps according to claim 1.

16. A computer program product comprising software code portions configured for, when run in a memory of a computer, executing the method steps according to claim 3.

17. A computer program product comprising software code portions configured for, when run in a memory of a computer, executing the method steps according to claim 6.

18. A computer program product comprising software code portions configured for, when run in a memory of a computer, executing the method steps according to claim 8.

19. The method according to claim 1, wherein the array of quantum dots is a three-dimensional array of quantum dots.

20. The computer according to claim 13, wherein the computer is further configured to:
determine a linear combination of physical gate voltages based on the inverse of the combined crosstalk matrix.
